(19) United States
(12) Patent Application Publication
(10) Pub. No.: US 2025/0285369 A1
(43) Pub. Date: Sep. 11, 2025

(54) RENDERING CONTROLLER CONFIGURED TO RENDER A THREE-DIMENSIONAL SCENE AND METHOD FOR THE SAME

(71) Applicant: HUAWEI CLOUD COMPUTING TECHNOLOGIES CO., LTD., Guizhou (CN)

(72) Inventors: Markus STEINBERGER, Munich (DE); Alexander WEINRAUCH, Graz (AT); Wolfgang TATZGERN, Graz (AT); Pascal STADLBAUER, Graz (AT)

(21) Appl. No.: 19/215,924

(22) Filed: May 22, 2025

Related U.S. Application Data
(63) Continuation of application No. PCT/EP2022/082737, filed on Nov. 22, 2022.

(51) Int. Cl. G06T 15/50

(52) U.S. Cl. CPC G06T 15/506

(57) ABSTRACT

One example rendering controller is configured to render a three-dimensional (3D) scene for a plurality of viewers, where the 3D scene includes a first plurality of objects and each viewer has a scene view of the 3D scene, where the rendering controller includes at least one processor and one or more memories coupled to the at least one processor and storing programming instructions for execution by the at least one processor to determine light transport for each scene view; determine, for each scene view, one or more objects affecting the scene view based on the light transport; compute respective rendering characteristics for each of a second plurality of objects affecting a scene view; store the respective rendering characteristics in a rendering cache associated with a corresponding object of the second plurality of objects; and compute display characteristics for the scene view based on the plurality of rendering caches.

### CROSS-REFERENCE TO RELATED APPLICATIONS

This application is a continuation of International Application No. PCT/EP2022/082737, filed on Nov. 22, 2022, the disclosure of which is hereby incorporated by reference in its entirety.

### TECHNICAL FIELD

The present disclosure relates generally to the field of virtual environments and more specifically, to a rendering controller configured to render a three-dimensional, 3D, scene and a method for use in the rendering controller.

### BACKGROUND

With the rapid advancement in innovative technologies, every aspect of life has been changed radically. Recently, with the development of three-dimensional (3D) technologies, for example, a 3D virtual environment has become widespread. The 3D virtual environment provides new ways to virtually explore a 3D designed virtual place, such as a 3D meeting room, a 3D classroom, a 3D museum, and the like. The 3D virtual environment is also used for playing video games or for virtual events, for example, a video conferencing. In the 3D virtual environment, a large number of users look at a same object from various viewing angles with various overlapping regions. To determine the appearance of a surface of each viewed object in the 3D virtual environment, various computations are required. In an example, global light transport is required to determine the incoming radiance for each point of the viewed surface. In another example, complex material models may require to be evaluated and various effects contribute to the final appearance. Conventionally, rendering is used to generate one or more images of the 3D virtual environment. Typically, rendering in the cloud is performed by separate instances of applications running in the cloud. Each instance may communicate with a central server (e.g., also running the cloud) to receive updates of the 3D virtual environment or receive the data that is required for image generation. Further, each instance streams resulting image to the user display by independently computing appearance of all visible screen fragments of each viewer. Each client's rendering is driven by current view location and focuses on the screen space of the viewer. That means rendering is driven from the output side, for example, tracing rays or paths into the scene from the current view of each individual client, computing special effects in screen space, like screen-space ambient occlusion, and the like. This approach leads to individual and independent rendering computations for each viewer, resulting in a strictly linear relationship between instance count and computation efforts. Moreover, real-time rendering systems divide the computations required for rendering the view of a scene into multiple rendering steps, each attuned to a specific effect, (e.g., shadow computations, direct illumination, reflections, diffuse global illumination, ambient occlusion, volumetric scattering, and the like.). As rendering computations are costly, the screen space typically serves as both acceleration structure and storage for spatio-temporal computation amortization, that prohibits sharing between different viewers, as each viewer's screen space is unrelated. Further, in the conventional approach, if multiple viewers view the same object or the same scene in the 3D virtual environment, all rendering computations are duplicated. However, storage and reuse of the screen space leads to resampling issues over time and discontinuities in space across object boundaries in the 3D virtual environment. Thus, there exists a technical problem of how to avoid individual and independent rendering computations for each viewer in the 3D virtual environment.

Therefore, in light of the foregoing discussion, there exists a need to overcome the aforementioned drawbacks associated with the conventional methods of rendering computations.

### SUMMARY

The present disclosure provides a rendering controller configured to render a three-dimensional (3D) scene for a plurality of viewers and a method for use in the rendering controller. The present disclosure provides a solution to the existing problem of how to avoid individual and independent rendering computations for each viewer of the 3D virtual environment. An objective of the present disclosure is to provide a solution that overcomes at least partially the problems encountered in the prior art and provides an improved rendering controller and an improved method for use in the rendering controller configured to render the 3D scene for the plurality of viewers.

One or more objectives of the present disclosure is achieved by the solutions provided in the enclosed independent claims. Advantageous implementations of the present disclosure are further defined in the dependent claims.

In one aspect, the present disclosure provides a rendering controller configured to render a three-dimensional (3D) scene for a plurality of viewers. The 3D scene comprises a plurality of objects and each viewer having a scene view of the 3D scene and each scene view is affected by one or more of the plurality of objects. The rendering controller is configured to, for each scene view, determine light transport, the light transport indicates how light is transported through the scene view and determine one or more objects affecting the scene view based on the light transport. The rendering controller is further configured to compute rendering characteristics for all objects affecting a scene view. Furthermore, the rendering controller is configured to store said rendering characteristics in a rendering cache associated with the corresponding object. Moreover, the rendering controller is configured to compute display characteristics for each scene view based on the rendering caches and at least one rendering cache is utilized for more than one scene view.

Beneficially, the 3D scene is rendered by the rendering controller in order to provide the scene view to each viewer from the plurality of viewers. Further, the scene view of each viewer depends upon position and orientation of the viewer in the 3D scene. Furthermore, rendering controller performs tracing light rays to determine the light transport indicates how light is transported through the scene view. The light transport is to determine one or more objects that are affecting the scene view. The rendering characteristics are stored in the rendering caches to reduce the number of computations for multiple viewers and share rendering computations among the viewers that are present at the same location and watching the same one or more objects from the plurality of objects. The rendering cache is used as a virtual memory by the rendering controller to store the rendering characteristics. Further, the display characteristics are computed. Further, the rendering controller computes display characteristics to generate an image that is further shared among plurality of viewers who are viewing the same object at same time.

In an implementation form, the rendering controller is further configured to determine a space in the 3D scene, the space comprising multiple light transport events, compute rendering characteristics for the space and store said rendering characteristics in a rendering cache associated with the space.

It is advantageous to determine the space in the 3D scene because one or more area with no objects is identified by the rendering controller. The rendering characteristics for the space are stored in the rendering caches associated with the space to reduce the number of computations for multiple viewers and share the rendering computations among the viewers that are present at the same location and watching the same space.

In a further implementation form, the rendering controller is further configured to associate one or more scene views in a subset, wherein two scene views are associated if they are overlapping. Further, the rendering controller is configured to determine a first compute node for computing a first aspect of light transport as part of the rendering characteristics for the subset and determine a second compute node for computing a second aspect of light transport as part of the rendering characteristics for the subset.

It is advantageous to associate one or more scene views in a subset if they are overlapping because the computation is required only once for the one or more scene view when they overlap. The computation of the first aspect of light transport and the second aspect of light transport provides the viewing angle of the first compute node and the second compute node which is used to determine that the scene is overlapped or not.

In a further implementation form, two scene views are associated if they are overlapping.

It is advantageous to associate two scene views if they are overlapping as the computation is required only once for both the scene views which reduces the computation cost and improve efficiency.

In a further implementation form, two scene views are associated if they cover areas within a threshold distance of one another.

It is advantageous to associate two scene views if they cover areas within a threshold distance of one another because an image of the one or more objects from the plurality of objects remain same under the threshold distance, so computation is required only for both the scene views.

In a further implementation form, two scene views are associated if the originating viewpoints are within a threshold distance of one another.

It is advantageous to associate two scene views if the originating viewpoints are within a threshold distance of one another because an image of the one or more objects from the plurality of objects remain same till the viewpoints are within a threshold distance from one another. The viewpoints within the threshold distance of one another enables the rendering controller to perform the computation only once for both the scene views.

In a further implementation form, the rendering controller is further configured to determine a view node for each scene view and to determine light transport and to compute display characteristics for a scene view in the view node.

It is advantageous to determine view node for each scene view as it enables the rendering controller to generate the image of the 3D scene according to the position and orientation of the viewer from the plurality of viewers. Further, the light transport provides a view of the one or more objects affecting the scene view. Furthermore, the display characteristics enables the rendering controller to generate the image for the scene view in the view node.

In a further implementation form, an object affects a first and a second scene view, wherein the rendering controller is configured to compute the rendering characteristics for the object only for the first scene view.

It is advantageous to compute the rendering characteristics for the object only for the first scene view because the computed rendering characteristics are shared with second scene view which reduces the cost to perform computation individually for each scene view. Further, the computation of the rendering characteristics for the first scene view is used for the second scene view by storing the rendering cache on the surface of the objects and in the space.

In a further implementation form, the rendering controller is further configured to determine a global illumination node and to determine rendering characteristics based on global illumination for all scene views in the global illumination node.

It is advantageous to determine global illumination node as it enables the rendering controller to generate clear image of the 3D scene. Further, the rendering characteristics are determined with respect to the global illumination node because the global illumination node increases the amount of light which improves the visual effects of the image.

In a further implementation form, a scene view is affected by an object by comprising the object and/or by receiving light emanating from the object.

It is advantageous to receive light emanating from the object as it makes the object visible in the scene view, thus improves the quality of the scene view.

In a further implementation form, light transport includes secondary lighting.

Beneficially, the secondary lighting is used in determination of the one or more objects in each scene view. Further, the secondary lighting provides more clear images of the one or more objects from the plurality of objects visible in the 3D scene. Furthermore, the secondary lighting enables the rendering controller to determine the light transport in the scene view.

In another aspect, the present disclosure provides a method for use in a rendering controller configured to render a three-dimensional (3D) scene for a plurality of viewers. The 3D scene comprises a plurality of objects and each viewer having a scene view of the 3D scene and each scene view is affected by one or more of the plurality of objects. The method comprises, for each scene view, determining light transport, the light transport indicates how light is transported through the scene view and determining one or more objects affecting the scene view based on the light transport. The method further comprises computing rendering characteristics for all objects affecting a scene view. Furthermore, the method includes storing said rendering characteristics in a rendering cache associated with the corresponding object. Moreover, the method comprises computing display characteristics for each scene view based on the rendering caches and at least one rendering cache is utilized for more than one scene view.

The method for use in the rendering controller achieves all the advantages and technical effects of the rendering controller of the present disclosure.

It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is block diagram of a rendering controller, in accordance with an embodiment of the present disclosure;

FIG. 2 is an implementation scenario of a rendering controller, in accordance with an embodiment of the present disclosure;

FIG. 3A is an implementation scenario that depicts cached ambient occlusion screen space and cache space, in accordance with an embodiment of the present disclosure;

FIG. 3B is an implementation scenario that depicts cached direct shadows from an area light source, in accordance with an embodiment of the present disclosure;

FIG. 4A is an implementation scenario that depicts tiles allocation without mip-mapping, in accordance with an embodiment of the present disclosure;

FIG. 4B is an implementation scenario that depicts tiles allocation with mip-mapping, in accordance with an embodiment of the present disclosure;

FIG. 5A is an implementation scenario that depicts cache to surface mapping, in accordance with an embodiment of the present disclosure;

FIG. 5B is a graphical representation of extended rendering over texture seams, in accordance with an embodiment of the present disclosure;

FIG. 6A is an implementation scenario that depicts mesh instance granularity visualization, in accordance with an embodiment of the present disclosure;

FIG. 6B is an implementation scenario that depicts UV island granularity visualization, in accordance with an embodiment of the present disclosure;

FIG. 7A is an implementation scenario that depicts simple cached dynamic diffuse global illumination, in accordance with an embodiment of the present disclosure;

FIG. 7B is an implementation scenario that depicts cached dynamic diffuse global illumination with different resolution, in accordance with an embodiment of the present disclosure;

FIG. 8 is an implementation scenario that depicts multi-viewer dynamic diffuse global illumination with activity, in accordance with an embodiment of the present disclosure;

FIG. 9A is an implementation scenario that depicts hash based free-space memory management, in accordance with an embodiment of the present disclosure;

FIG. 9B is an implementation scenario that depicts difference between global and local lookup table, in accordance with an embodiment of the present disclosure;

FIG. 10 is an illustration of a multi-viewer distribution scheme, in accordance with an embodiment of the present disclosure;

FIG. 11 is a flow chart of a method for use in rendering controller, in accordance with an embodiment of the present disclosure;

FIG. 12 is an implementation scenario that depicts sharing computations between cameras of autonomous vehicles, in accordance with an embodiment of the present disclosure; and

FIG. 13 is an implementation scenario that depicts capture occluded and reappearing parts of scenes, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

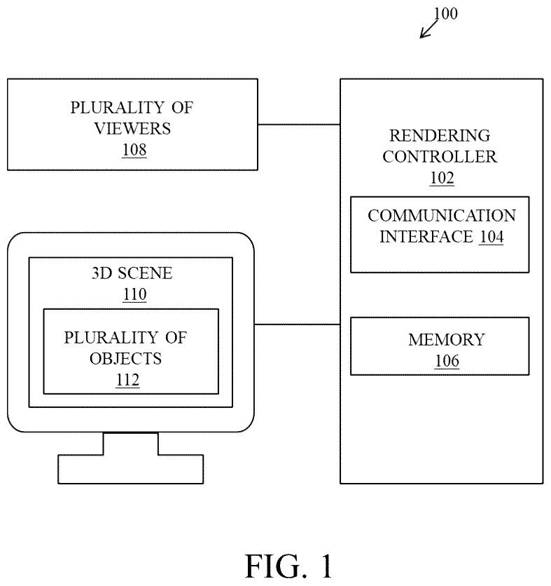

FIG. 1 is block diagram of a rendering controller, in accordance with an embodiment of the present disclosure. With reference to FIG. 1, there is shown a block diagram 100 of a rendering controller 102 that includes a communication interface 104, and a memory 106. There is further shown a plurality of viewers 108, and a three-dimensional (3D) scene 110 comprising a plurality of objects 112.

The rendering controller 102 may include suitable logic, circuitry, interfaces, and/or code that is configured to provide access of the 3D scene 110 to the plurality of viewers 108. The rendering controller 102 may be further configured to provide a live feed of the 3D scene 110 to the plurality of viewers 108. Examples of implementation of the rendering controller 102 may include, but are not limited to, a processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The communication interface 104 may include suitable logic, circuitry, and/or interfaces that is configured to communicate data to the plurality of viewers 108. Examples of implementation of the communication interface 104 may include but are not limited to a network interface, a computer port, a network socket, a network interface controller (NIC), and any other network interface device.

The memory 106 may include suitable logic, circuitry, and/or interfaces that is configured to store data related to the 3D scene 110 that includes but not limited to, virtual areas of the 3D scene 110, position of the plurality of objects 112, position of a plurality of virtual characters, audios, videos, and the like. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The plurality of viewers 108 are the users of the 3D scene 110. The 3D scene 110 may also be referred to as a 3D virtual environment.

The rendering controller 102 is configured to render the three-dimensional (3D) scene 110 for the plurality of viewers 108. The 3D scene 110 includes the plurality of objects 112 and each viewer having a scene view of the 3D scene 110. Further, each scene view is affected by one or more of the plurality of objects 112. In an implementation, the rendering controller 102 may be communicably coupled to a plurality of devices (e.g., a smart phone, a laptop, a desktop, a tablet, and the like) associated with the plurality of viewers 108. Further, the rendering controller 102 is configured to enable the plurality of viewers 108 to view the 3D scene 110. The rendering controller 102 is further configured to manage the scene view of the 3D scene 110 for each viewer. The 3D scene 110 refers to a virtual construct (e.g., a virtual model) designed through any suitable 3D modelling technique and computer assisted drawings (CAD) methods that enables exploration thereof and communications between users through their corresponding virtual characters. Thus, the 3D scene 110 may be a virtual meeting platform or videoconferencing platform having a virtual setting where users may walk around, see each other's virtual character, and communicate with each other. Examples of the 3D scene 110 may include, but are not limited to, a 3D roller coaster, a 3D haunted house in an entertainment park, an entertainment park, 3D video games, a 3D museum, a 3D city, school, factory, or any venue, and the like. Further, the plurality of objects 112 in the 3D scene 110 are virtual objects imitating real objects that may include but are not limited to a vehicle (e.g., a car), a plurality of vehicles, a plurality of buildings, and the like. The scene view of the 3D scene 110 includes front scene view, back scene view, side scene views and the like. Furthermore, the one or more of the plurality of objects 112 affects each scene view as the scene view changes when a viewer changes its position in the 3D scene 110. In an implementation, the change in position of each viewer leads to change in perspective of the one or more of the plurality of objects 112 that affects the scene view of the 3D scene 110. In another implementation, the change in position of each viewer leads to appearance of a new object that affects the scene view of the 3D scene 110. The rendering controller 102 uses a virtual memory system to store caches in the 3D scene 110. Further, the cache is of two types, one is cache associated with the plurality of objects 112 of the 3D scene 110 and another is cache associated with the space. These caches are stored in the memory 106 of the rendering controller 102 as they capture intermediate values of light transport.

In accordance with an embodiment, the rendering controller 102 is a cloud controller. In an implementation, the rendering controller 102 may be used in a cloud server, hence, the rendering controller 102 may be termed as the cloud controller.

The rendering controller 102 is configured to determine light transport for each scene view. Further, the light transport indicates how light is transported through the scene view. The rendering controller 102 is configured to determine the light transport through a general caching system with an affinity to the 3D scene 110 that is rendered from various viewpoints.

The rendering controller 102 is configured to determine one or more objects affecting the scene view based on the light transport for each scene view. In other words, the light transport provides a view of the one or more objects affecting the scene view. Further, the light transport provides the view of only a part of the object that is visible from a particular angle.

In accordance with an embodiment, the light transport includes secondary lighting. The secondary lighting may also be referred to as an indirect lighting that moves from one object to another object in each scene view of the 3D scene 110. The secondary lighting is used in determination of the one or more objects in each scene view. The secondary lighting is used to provide clear images of the one or more objects from the plurality of objects 112 visible in the 3D scene 110. Further, the secondary lighting enables the rendering controller 102 to determine the light transport in the scene view having low resolution as well.

In accordance with an embodiment, the scene view is affected by an object by comprising the object and/or by receiving light emanating from the object. In other words, the light emanating from the object makes the object visible in the scene view, thus affects the scene view. The light emanating from the object may be either direct light or indirect light. The scene view changes as the viewer changes its location and orientation (e.g., viewing angle) as there may be a different object in another location. In one implementation, the changes in location and orientation leads to change in perspective of the same object.

The rendering controller 102 is further configured to compute rendering characteristics for all objects affecting a scene view. The rendering characteristics includes ideal location and resolution of caches. Further, if the plurality of viewers 108 view the one or more objects in the 3D scene 110 from same perception, then same object appears in each scene view of the corresponding viewer. In such scenario, the caches are merged for each scene view of the corresponding viewer to reduce number of caches that are generated. In an implementation, the caches of the scene view of the first viewer 108A and the caches of the scene view of the second viewer 108B are merged. In another implementation, the caches of the scene view of the first viewer 108A, second viewer 108B and Nth viewer are merged. Further, the most relevant data of the catch entries is stored, and the resolution is chosen based on an effect frequency.

The rendering controller 102 is further configured to store said rendering characteristics in a rendering cache associated with the corresponding object. The rendering cache is considered as a virtual memory system which is configured to store the rendering characteristics associated with the corresponding object from the plurality of objects 112. The rendering cache may capture intermediate values of light transport affecting the one or more objects from the plurality of objects 112. The rendering cache may be classified as an on-surface cache and an in-space cache. The on-surface cache is sparse and multi-resolution in nature. The on-surface-cache can be stored on the surface of 3D objects in a virtual scene and the rendering computations can be shared among the plurality of viewers 108. The in-space cache is configured to capture a sparse, hierarchical grid in a virtual scene of 3D objects. Further, the memory management for caches on the surfaces of the plurality of objects 112 is performed on multiple granularities.

The rendering controller 102 is further configured to compute display characteristics for each scene view based on the rendering caches and at least one rendering cache is utilized for more than one scene view. The rendering cache is generated in such a way that the generation of the rendering cache is distributed between different compute nodes and merging computations based on required data, such as scene geometry, textures, and the like. The temporal coherence and progressive cache updates based on the type of effect, required update frequency and available compute power are used. The transfer of cache data from generation nodes to display nodes, where the final views for individual viewers are synthesized. The plurality of viewers 108 are grouped based on their cache requirements, closeness in the 3D scene 110, and data residency. Moreover, the virtual cache memory is managed by various parameters like, location of the plurality of viewers 108, an orientation of the plurality of viewers 108, a geometric constellation of the 3D scene 110 and effects considered by the rendering approach.

In accordance with an embodiment, the rendering controller 102 is further configured to determine a space in the 3D scene 110, the space includes multiple light transport events. Further, the rendering controller 102 is configured to compute rendering characteristics for the space and store said rendering characteristics in a rendering cache associated with the space. The multiple light events provide a view of the space in the 3D scene 110. The in-space cache is used to store the computed rendering characteristics associated with the space in the 3D scene 110. In an implementation, the space may include one or more of the plurality of objects 112. In another implementation, the space may be an empty area. The multiple light transport events provide a view of the 3D scene 110, and the space may be an empty area in the 3D scene 110. In other words, the rendering in the 3D scene 110 is distributed with respect to effect that allows different nodes to compute different effects, such as resolution of the screen, screen space, and the like. In another implementation the effects are influenced by transmission latencies or frequency of occurrence. The rendering effects help to predict potentially needed future scene parts in which the effects are required, and the scene parts that allow for precomputation. In one implementation, rendering effects that change slowly or are predicted to occur in the future, are computed with higher transmission latency from a receiver (e.g., a cloud), while the final image generation is performed on compute devices with lower transmission latency (e.g., either close to a client or at the client). If more than one viewer views the 3D scene 110 from similar viewpoint, then the stored rendering characteristics in the rendering cache associated with the space is shared among the viewers to create a common image for all viewers. The rendering cache associated with the space are shared among the viewers is to reduce memory transfer. The multiple light transport events provide visuals of the plurality of objects 112. Further, the rendering characteristics store arbitrary (intermediate) data from rendering computations in the 3D scene 110. Furthermore, the rendering cache associated with the space stores values that range from individual bits, over scalar floating-point values, multi-dimensional data, and distributions. Moreover, the rendering cache associated with the space may store additional information to disallow interpolation if a blocking structure lies between entries.

In accordance with an embodiment, an object affects a first and a second scene view. Further, the rendering controller 102 is configured to compute the rendering characteristics for the object only for the first scene view. In an implementation scenario, if a first viewer from the plurality of viewers 108 views the first scene view having an object and a second viewer from the plurality of viewers 108 views the second scene view having the same object. In such scenario, the rendering controller 102 is configured to compute the rendering characteristics for the object only for the first scene view. The reason being the first object is common in the first and the second scene view. Alternatively stated, if the same point on a surface is visible in more than one view, computations can be stored on the surface (for example, by use of the on-surface cache) and shared among viewers (i.e., the plurality of viewers 108). If the computations stored in space is required by more than a single view, computations can be reused. In this way, the on-surface cache and in-space cache enable spatio-temporal computations sharing across multiple views in the 3D scene 110. By virtue of the ability to store computations in caches (e.g., the on-surface cache and the in-space cache) coherent among viewers, all view-independent rendering computations can be shared among viewer that feature overlaps, and many view-dependent computations can be shared. The sharing of rendering computations can be performed on the basis of a per-effect basis, which naturally integrates into current rendering engine designs. For example, instead of computing ambient occlusion in the screen space for each viewer, the ambient occlusion shadowing coefficients are stored on all surface locations that are visible in any view by the rendering controller 102. The resulting caches are then made available among all viewers (i.e., the plurality of viewers 108) which use the results in the final image generation process. This shifts many computations from each individual instance to the rendering controller 102, and overall reduces computation costs proportional to the reuse in all caches.

In accordance with an embodiment, the rendering controller 102 is further configured to associate one or more scene views in a subset and two scene views are associated if they are overlapping. Further, the rendering controller 102 is to determine a first compute node for computing a first aspect of light transport as part of the rendering characteristics for the subset. Furthermore, the rendering controller 102 is to determine a second compute node for computing a second aspect of light transport as part of the rendering characteristics for the subset. In other words, if the first viewer from the plurality of viewers 108 is viewing the 3D scene 110 from one angle and the second viewer from the plurality of viewers 108 is also viewing the 3D scene 110 from the similar angle then, the scene viewed by the first viewer and the second viewer is overlapped. The computation of the first aspect of light transport and the second aspect of light transport provides the viewing angle of the first compute node and the second compute node which is used to determine that the scene is overlapped or not. The rendering controller 102 provides a view-independent, dynamic cache structures that allow the sharing of rendering computations among different views in the 3D scene 110. The rendering caches associated with the corresponding object from the plurality of objects 112 and rendering caches associated with the space are shared among viewers (i.e., the plurality of viewers 108). Through this way, the computation of the rendering characteristics is performed only once and reused by all viewers. The rendering caches are stored separately for different effects that allows to change frequency as per updates. Further, the resolution for all the rendering caches is updated that saves more computations.

In accordance with an embodiment, two scene views are associated if they are overlapping. In an implementation, the first viewer from the plurality of viewers 108 is viewing an object from the plurality of objects 112 in the 3D scene 110 from one angle and the second viewer from the plurality of viewers 108 is also viewing the same object in the 3D scene 110 but from another angle then, the scene viewed by the first viewer and the second viewer is not overlapped as the first viewer and the second viewer is viewing the same object but from different viewing angles. Hence, the perspective of each viewer is different because of different viewing angle. In another implementation, the first viewer from the plurality of viewers 108 is viewing one of the plurality of objects 112 in the 3D scene 110 from an angle and the second viewer from the plurality of viewers 108 is also viewing the same object in the 3D scene 110 from same angle then, the scene viewed by the first viewer and the second viewer is overlapped as the first viewer and the second viewer is viewing the object from same viewing angle. Hence, perspective of each viewer is same because of same viewing angles. Therefore, the rendering controller 102 shares the rendering computations of the object in the 3D scene 110 among the first viewer and the second viewer.

In accordance with an embodiment, two scene views are associated if they cover areas within a threshold distance of one another. In an implementation, the first viewer from the plurality of viewers 108 views an object from the plurality of objects 112 in the 3D scene 110 and a first side, a second side and a third side of the object is visible to the first viewer. The second viewer from the plurality of viewers 108 also views the same object in the 3D scene 110 but only the first side and the second side of the object is visible to the second viewer. In such scenario, the scene view of the second viewer is under the threshold distance of the scene view of the first viewer. In another implementation, if the first viewer from the plurality of viewers 108 views an object from the plurality of objects 112 in the 3D scene 110 and a first side, a second side and a third side of the object is visible to the first viewer. The second viewer from the plurality of viewers 108 also views the same object in the 3D scene 110 but only the third side and a fourth side of the object is visible to the second viewer. In such scenario, the scene view of the second viewer is not under the threshold distance of the scene view of the first viewer.

In accordance with an embodiment, two scene views are associated if the originating viewpoints are within a threshold distance of one another. In an implementation, the first viewer and the second viewer are partially at same location in the 3D scene 110. Further, the scene view of both the viewers is almost similar which indicates that originating viewpoints of the scene view of the first viewer and the second viewer is within the threshold distance of one another. So, the rendering controller 102 provides a common image to both the viewers using the rendering caches stored on the surface of the objects.

In an implementation, one cache entry per mesh instance is performed. In another implementation, multiple cache entries per mesh instances based on UV-Islands is performed. The UV-Islands are connected components of triangles of a single mesh. In one implementation, a coarser granularity result in over allocation of memory because only a small subset of a mesh is visible on the screen. To mitigate memory overhead, sparse textures are used that allow to allocate memory only to required texel blocks. A texel, texture element, or texture pixel is the fundamental unit of a texture map. Textures are represented by arrays of texels representing the texture space, just as other images are represented by arrays of pixels. In such scenario, layered textures are used for finer granularities that has lower resolutions instead of sparse textures as they do not perform well due to minimum memory consumption. The memory is allocated to the required regions from multiple pre-allocated memory pools for sparse textures. Further, each effect has its own memory pools to prioritize memory to effects with a high computational cost. In another implementation, the first viewer from the plurality of viewers 108 views an object from the plurality of objects 112 in the 3D scene 110 and a first side and a second side of the object is visible to the first viewer from a viewpoint. The second viewer from the plurality of viewers 108 also views the same object in the 3D scene 110, near to the viewpoint of the first viewer. In such implementation scenario, the viewpoint of the first viewer and the second viewer is not the same but both are able to see the first side and the second side of the object that indicates the scene views of the first viewer and the second viewer are associated as they cover areas within a threshold distance of one another.

In accordance with an embodiment, the rendering controller 102 is further configured to include the space in a subset, wherein the space is included in a scene view associated with the subset. The cache associated with the space is required for certain areas like, the areas with visible surfaces and in a reach of light. In an implementation, only a subset of cache entries is active. In another implementation, the allocated cache entries are disabled. In yet another implementation, the cache entries are never activated and never allocated. Further, a list of all active rendering cache associated with the space is kept per effect in order to efficiently fill the caches. The rendering caches associated with the plurality of objects 112 are updated when the cache associated with the space is sampled. In an implementation, the resolution of the rendering caches associated with the space depends on the distance to the viewers. In another implementation, the resolution of the rendering caches associated with the space depends on the screen space derivatives projected back to the 3D scene 110. Further, the rendering caches associated with the space are handled in tiles. Although, the rendering caches associated with the space are also handled as individual entries during allocation. The rendering caches associated with the space are filled similar as the rendering caches associated with the plurality of objects 112 are filled.

In accordance with an embodiment, the rendering controller 102 is further configured to determine a view node for each scene view and to determine light transport and to compute display characteristics for a scene view in the view node. The view node defines a point from which a scene view is displayed to a viewer. The light transport defines parameter of the visibility of the plurality of objects 112 and space in the 3D scene 110. The rendering controller 102 computes the display characteristics for the scene view. The rendering controller 102 provides a view-independent, dynamic cache structures that allow the sharing of rendering computations among different views in the 3D scene 110. The rendering caches associated with the corresponding object from the plurality of objects 112 and rendering caches associated with the space are shared among viewers. Through this way, the computation of the rendering caches is performed only once to reuse by all viewers. The rendering caches are stored separately for different effects that allows to change frequency as per updates. Further, the resolution for all the rendering caches is updated that saves more computations.

The rendering controller 102 provides an efficient way to share different scene views of the 3D scene 110 by reuse of the rendering computations. Further, the rendering controller 102 decreases the cost by reducing the light transport computations because they are costly to compute. The rendering controller 102 splits the rendering computations and enables parallelization and pipelining across compute nodes. Further, the rendering controller 102 is configured to perform sharing of rendering computations among the plurality of viewers 108 in the 3D scene 110 which leads to a decrease in the rendering cost as well. This way of performing the rendering in the cloud allows a wider scaling, as the rendering controller 102 scales rendering in a significantly improved way. Furthermore, the rendering controller 102 enables the spatial reuse as well as the temporal reuse of the rendering computations. The rendering controller 102 does not rely on the screen space for storage and reuse of the effect computations as it leads to resampling issues over time and discontinuities in space across boundaries of the object. The rendering controller 102 is configured to store and reuse rendering computations. Further, the rendering controller 102 provides a new space to reuse the rendering computations over time without resampling.

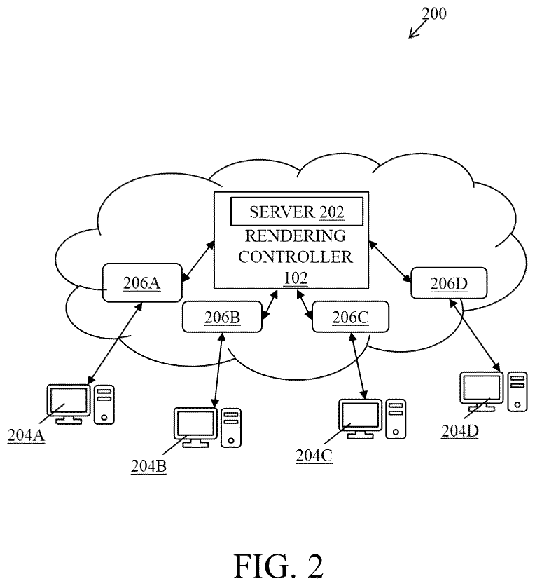

FIG. 2 is an implementation scenario of a rendering controller, in accordance with an embodiment of the present disclosure. FIG. 2 is described in conjunction with elements from FIG. 1. With reference to FIG. 2, there is shown an implementation scenario 200 that depicts the server 202 comprising the rendering controller 102. There is further shown a first scene view 204A, a second scene view 204B, a third scene view 204C, and a fourth scene view 204D. There is further shown a first instance 206A associated with the first scene view 204A, a second instance 206B associated with the second scene view 204B, a third instance 206C associated with the third scene view 204C, and a fourth instance 206A associated with the fourth scene view 204D.

Conventionally, rendering for a 3D scene in a cloud is performed separately for each viewer among multiple viewers. The rendering for each scene view is driven by the current view location and focuses on the screen space of the viewer. The rendering is driven from the output side by tracing rays into the scene view from the current viewpoint of each viewer. Through this way all rendering computations being carried out individually and independently for all the viewers. To avoid rendering individually for each viewer, the view-independent, dynamic cache structures is disclosed in the FIG. 2. The view-independent, dynamic cache structures allow the sharing of rendering computations among different scene views in the 3D scene 110. In an implementation, if the viewers of the first scene view 204A, the second scene view 204B, the third scene view 204C, and the fourth scene view 204D are viewing an object in the 3D scene 110 from similar viewpoint, then the rendering controller 102 performs the centralized rendering to generate one image for the first instance 206A, the second instance 206B, the third instance 206C, and the fourth instance 206D. The rendering controller 102 performs the sharing on a per-effect basis. The rendering controller 102 is configured to store intermediate rendering results on all surface locations that are visible in any view of the 3D scene 110. Similarly, the rendering controller 102 is also configured to store rendering caches in space. The rendering cache associated with the space may store arbitrary data from rendering computations at any point in the 3D scene 110. Thereafter, the caches are used by the rendering controller 102 to generate final images for each viewer (i.e., the plurality of viewers 108).

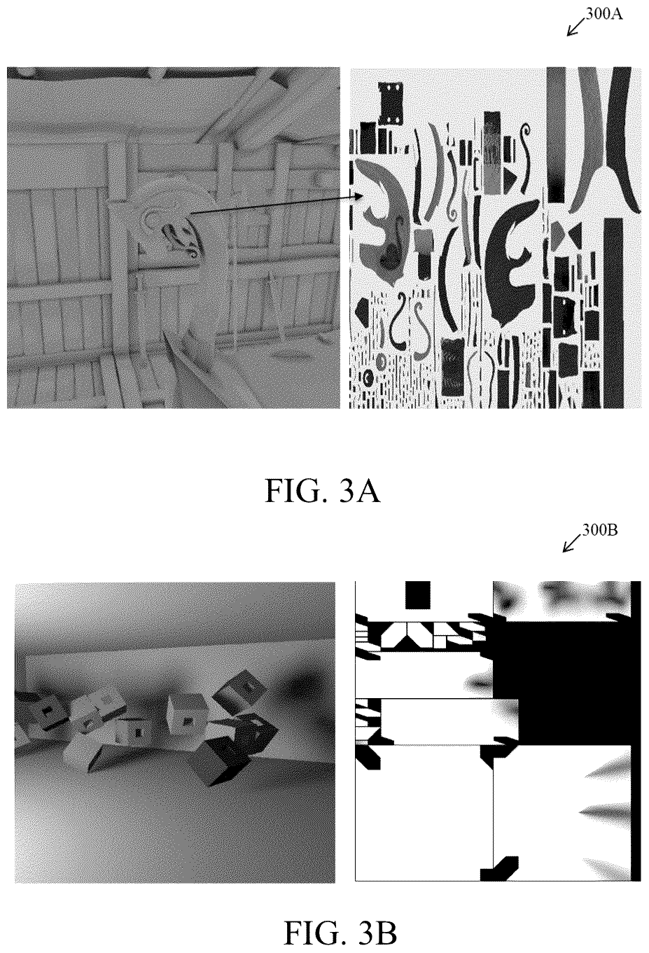

FIG. 3A is an implementation scenario that depicts cached ambient occlusion screen space and cache space, in accordance with an embodiment of the present disclosure. FIG. 3A is described in conjunction with elements from FIGS. 1 and 2. With reference to FIG. 3A, there is shown an implementation scenario 300A that depicts cached ambient occlusion in screen space (on left side) and cache space (on right side).

Generally, the ambient occlusion is computed for each pixel on screen by tracing rays in a hemisphere around each pixel location in a 3D space. The computation for each pixel on screen results in shadow coefficients of ambient occlusion that is used to lower the global illumination.

FIG. 3B is an implementation scenario that depicts cached direct shadows from an area light source, in accordance with an embodiment of the present disclosure. FIG. 3B is described in conjunction with elements from FIGS. 1, 2 and 3A. With reference to FIG. 3B, there is shown an implementation scenario 300B that depicts cached direct shadows from an area light source.

In general, the shadows are computed by tracing rays towards all light sources that may directly illuminate the pixel. The computation of the shadows by tracing the rays depends upon visibility of the light source. Further, final pixel color is computed with the influence of the light.

Moreover, as shown in FIGS. 3A and 3B, the rendering cache (e.g., on-surface caches) is associated with the corresponding object from the plurality of objects 112 comprised by the 3D scene 110. The rendering controller 102 is configured to store an arbitrary data from the rendering cache associated with the corresponding object from the plurality of objects 112. Further, the example for arbitrary data includes irradiance, shadowing factors, global illumination, visibility of light transport. Further, the rendering controller 102 is configured to store values of the arbitrary data that ranges from individual bits, over scalar floating-point values, multi-dimensional data, distributions and the like. The rendering cache associated with the corresponding object from the plurality of objects 112 use a parameterization from the 3D scene 110 to a 2D scene. Further, the rendering cache associated with the corresponding object from the plurality of objects 112 uses texture unwrapping for the parameterization. The texture unwrapping provides a spatially coherent space that includes continuous movement on the surface which results in continuous movement in the cache space. The parameterization is smooth, so it allows interpolation when the rendering controller 102 performs storing of the rendering caches at a discrete location. Moreover, the parameterization may use without concerning the resolution of the rendering cache associated with the corresponding object from the plurality of objects 112. In an implementation, the stored rendering cache is generated, relying on the parameterization for a consistent space. In another implementation, the stored rendering cache is updated over time, relying on the parameterization for the consistent space.

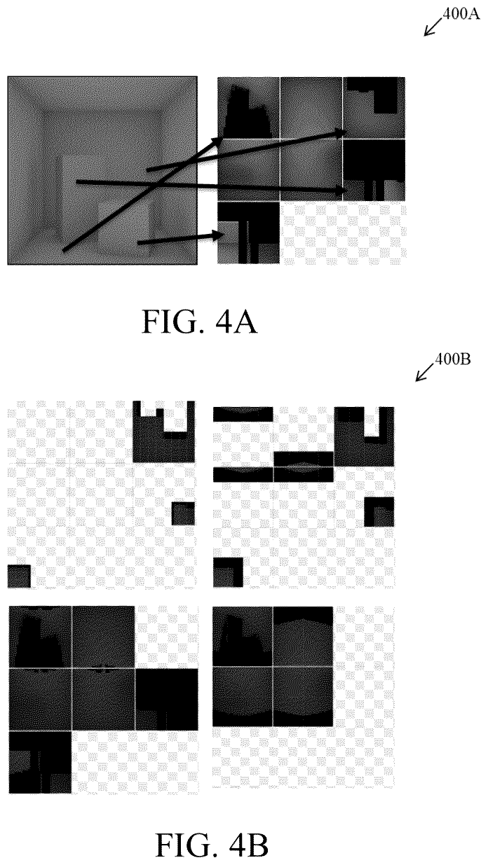

FIG. 4A is an implementation scenario that depicts tiles allocation without mip-mapping, in accordance with an embodiment of the present disclosure. FIG. 4A is described in conjunction with elements from FIGS. 1, 2, 3A and 3B. With reference to FIG. 4A, there is shown an implementation scenario 400A that depicts tiles allocation without mip-mapping.

Generally, the mip-mapping is used to avoid aliasing artefacts. Aliasing occurs when the scene view of the 3D scene 110 includes fine and repetitive details that exceed sensor resolution. Although, the FIG. 4A discloses about allocation of the tiles without mip-mapping. The arrows represented in the FIG. 4A, points towards the tile of each portion of the corresponding object from the plurality of objects 112 in the 3D scene 110.

FIG. 4B is an implementation scenario that depicts tiles allocation with mip-mapping, in accordance with an embodiment of the present disclosure. FIG. 4A is described in conjunction with elements from FIGS. 1, 2, 3A, 3B, and 4A. With reference to FIG. 4B, there is shown an implementation scenario 400B that depicts tiles allocation with mip-mapping.

The tiles allocation with the mip-mapping with various size of the tiles is represented in FIG. 4B. The mip-mapping is configured to assist in filling the on-surface cache by minimizing distortion and reducing memory requirements.

Moreover, as shown in FIGS. 4A and 4B, to fill the on-surface caches, the rendering controller 102 firstly determines where on-surface caches are required, for example, primary and secondary visibility. Further, the rendering controller 102 is configured to determine the resolution required for the on-surface cache. In an implementation, the rendering controller 102 uses rasterizer derivatives to determine the resolution required for the on-surface cache. In another implementation, the rendering controller 102 uses ray differential to determine the resolution required for the on-surface cache. Furthermore, the rendering controller 102 is configured to determine whether a cache of correct resolution is already present for a particular surface point or not. If there is no cache present of correct resolution for the particular surface, then the rendering controller 102 allocates a suitable cache for the particular surface point or may use a potentially existing cache with a resolution that is close to the correct resolution. Further, the rendering controller 102 is configured to create a cache-to-surface mapping as shown in the FIG. 4B. Furthermore, the tiles in which updates of cache is required are marked by the rendering controller 102 and then the updated caches are provided to the marked tiles. The tiles that are needed to be updated are stored for each effect that is being cached. Further, each cache stored in the tiles may have threads that are executed in parallel to fill or update the caches. The number of threads and type of threads varies according to effects. In an implementation, one ray per light source may be started for direct lighting. In another implementation, one compute shader thread per entry may be launched for filtering. Moreover, each thread uses the cache-to-surface mapping to have access to the location in the 3D scene 110 and other data stored on the surface of the corresponding object form the plurality of objects 112.

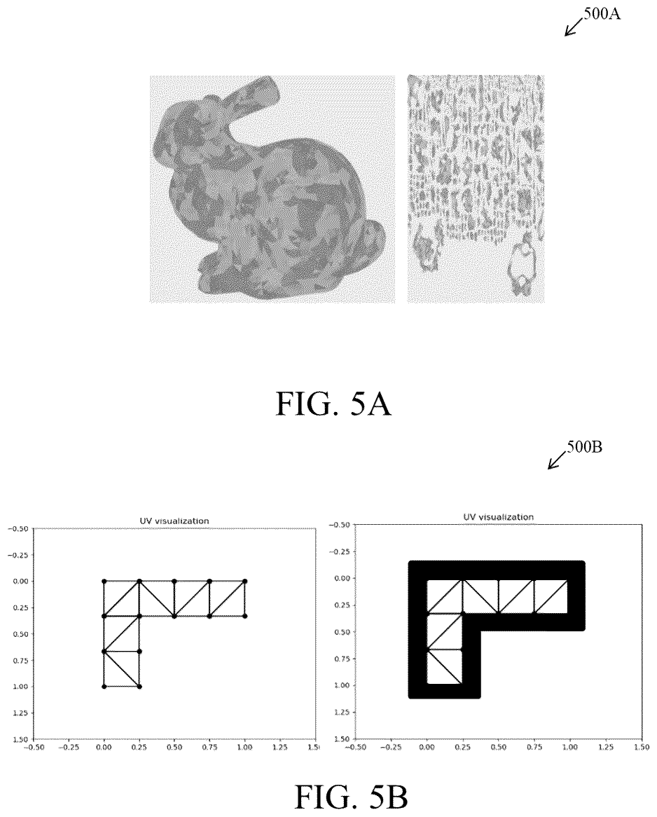

FIG. 5A is an implementation scenario that depicts cache to surface mapping, in accordance with an embodiment of the present disclosure. FIG. 5A is described in conjunction with elements from FIGS. 1, 2, 3A, 3B, 4A and 4B. With reference to FIG. 5A, there is shown an implementation scenario 500A that depicts cache to surface mapping.

The rendering controller 102 is configured to use the surface primitive identification associated with the surface to perform the cache to surface mapping. In an implementation, the rendering controller 102 uses triangle identification for triangle meshes. In another implementation, the rendering controller 102 uses quad identification for smooth surfaces. In yet another implementation, the rendering controller 102 uses patch identification for smooth surfaces. Further, the rendering controller 102 reconstructs a location stored in the surface primitive identification and in the in-space using a primitive data. Furthermore, the rendering controller 102 uses the primitive data to reconstruct other information, such as interpolated parameters and the like. The rendering controller 102 is configured to rasterizer the surface identification primitives with their primitive-to-cache mapping to create the cache to surface mapping. Further, the cache to surface mapping is stored in a duplicate of the cache itself which also holds the surface primitive identification instead of the data related to cache and this leads to memory management.

FIG. 5B is a graphical representation of extended rendering over texture seams, in accordance with an embodiment of the present disclosure. FIG. 5A is described in conjunction with elements from FIGS. 1, 2, 3A, 3B, 4A, 4B and 5A. With reference to FIG. 5B, there is shown a graphical representation 500B of extended rendering over texture seams.

In the implementation scenario shown in FIG. 5B, the rendering controller 102 may be configured to handle the seams at the cache space through rasterization of the primitives and thereafter, setting an identifier instead of only rasterizing the primitives. The identifier includes a stencil mask, and the like. Further, the rendering controller 102 is configured to render the primitives again. In such scenarios, the rendering controller 102 enlarges the primitives to cover at least two additional texels and uses a depth function that increases depth with the distance to an original triangle. Based on the stencil and the depth test, the primitive identifiers are written to the closest triangle outside the primitives. While filling the cache, the rendering controller 102 is configured to cache the data outside the original primitive depending upon a virtual extension of the primitives. In another implementation, the rendering controller 102 may be configured to handle the seams at the cache space by duplicating the primitives around seams and adds the duplicate primitives to the mapping of neighboring mapping instead of only adding primitives to one cache space mapping. By keeping a copy of primitives with their own primitive identifiers that are only accessible from the cache seam duplication and further helps in creating additional cache entries around seams.

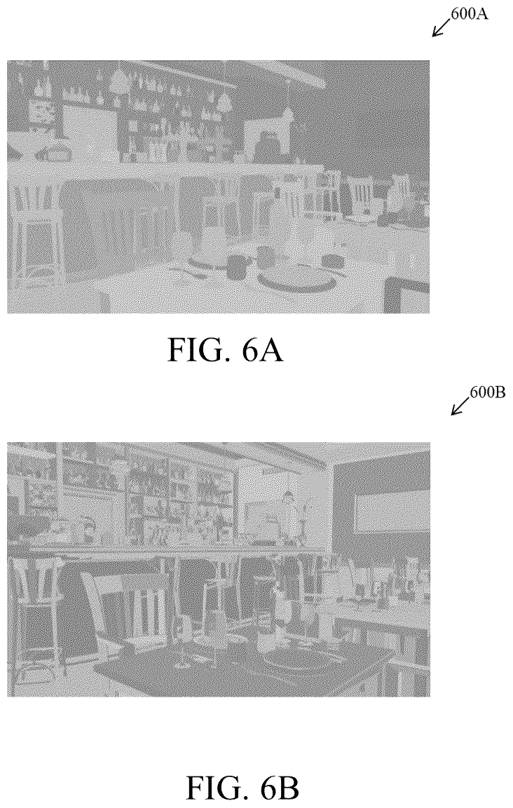

FIG. 6A is an implementation scenario that depicts mesh instance granularity visualization, in accordance with an embodiment of the present disclosure. FIG. 6A is described in conjunction with elements from FIGS. 1, 2, 3A, 3B, 4A, 4B, 5A and 5B. With reference to FIG. 6A, there is shown an implementation scenario 600A that depicts mesh instance granularity visualization.

The memory management for on-surface caches is performed on multiple granularities by the rendering controller 102. In an implementation, the multiple granularities include one cache entry per mesh instance. The rendering controller 102 uses sparse textures that allow to allocate memory only to required texel blocks that avoids the problem of over allocation of memory due to visibility of only a small subset of a mesh during a coarse granularity. The rendering controller 102 is further configured to use layered textures for finer granularities because the sparse textures do not perform well for the finer granularities as the sparse textures consumes minimum memory. Further, the memory is allocated to the required regions from multiple pre-allocated memory pools for sparse textures. Furthermore, the required regions include separate memory pool for each effect. Moreover, in case of traditional textures, the rendering controller 102 allocates a fixed number of textures with different resolutions and assigns them to visible objects based on the required resolution. When, the viewer changes the viewpoint, the mapping is updated to account for a higher required resolution. While remapping the content of the cache of lower resolution is copied over to the cache of higher resolution to increase the temporal reuse. If an object from the plurality of objects 112 has not accessed the high-resolution levels of mip-levels of the cache recently, then the corresponding object is demoted to a lower resolution cache where the information of the higher mip-levels is lost.

FIG. 6B is an implementation scenario that depicts UV island granularity visualization, in accordance with an embodiment of the present disclosure. FIG. 6B is described in conjunction with elements from FIGS. 1, 2, 3A, 3B, 4A, 4B, 5A, 5B and 6A. With reference to FIG. 6B, there is shown an implementation scenario 600B that depicts UV island granularity visualization.

In an implementation, the multiple granularities include multiple cache entries per mesh instances based on UV-islands. Further, the UV-islands are connected components of triangles of a single mesh. The granularity visualization assists in the memory management as already described in detail, for example, in the FIG. 6A.

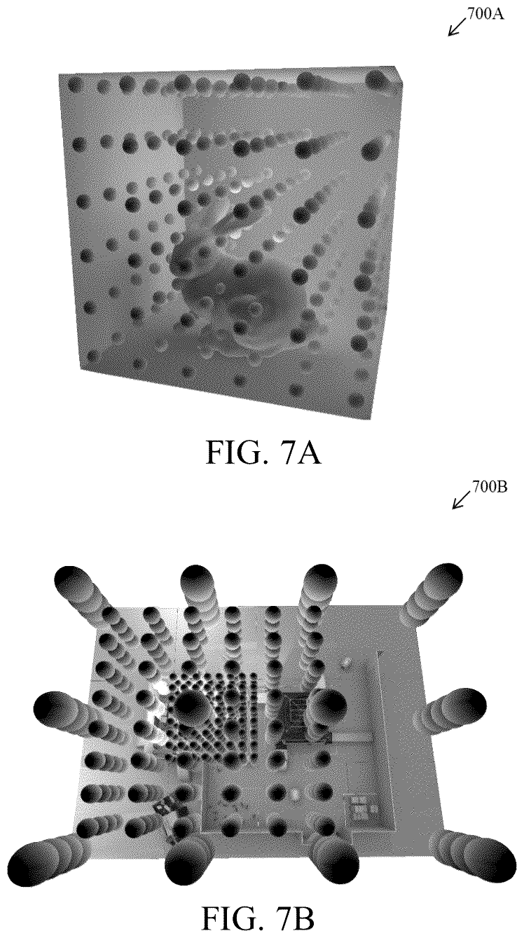

FIG. 7A is an implementation scenario that depicts simple cached dynamic diffuse global illumination, in accordance with an embodiment of the present disclosure. FIG. 7A is described in conjunction with elements from FIGS. 1, 2, 3A, 3B, 4A, 4B, 5A, 5B, 6A and 6B. With reference to FIG. 7A, there is shown an implementation scenario 700A that depicts simple cached dynamic diffuse global illumination.

In general, dynamic diffuse global illumination is computed by placing dynamically updated light-probes in a 3D space. Further, the probes are updated using raytracing in a specific time. Thereafter a data from the probes is taken to compute the lighting of final pixels. The in-space caches are stored in the space of the 3D scene 110.

FIG. 7B is an implementation scenario that depicts cached dynamic diffuse global illumination with different resolution, in accordance with an embodiment of the present disclosure. FIG. 7B is described in conjunction with elements from FIGS. 1, 2, 3A, 3B, 4A, 4B, 5A, 5B, 6A, 6B and 7A. With reference to FIG. 7B, there is shown an implementation scenario 700B that depicts cached dynamic diffuse global illumination with different resolution.

The 3D scene 110 having cached dynamic diffuse global illumination with different resolution includes parts with variation in the resolution. Further, interpolation of differently resolution grids may require special case handling.

Moreover, as shown in FIGS. 7A and 7B, the rendering cache associated with the space may store arbitrary data from rendering computations at any point in the 3D scene 110. Further, the rendering cache associated with the space stores values that range from individual bits, over scalar floating-point values, multi-dimensional data, and distributions. The rendering cache associated with the space typically use a regular grid to allow for efficient access from arbitrary locations in the 3D scene 110. In an implementation, the location of the caches has additional offset to place the caches closer to the surface within the 3D scene 110 they are assigned. In another implementation, the location of the caches has an additional offset to place the caches at more important locations within the 3D scene 110 they are assigned. Moreover, the rendering cache associated with the space store additional information to disallow interpolation if a blocking structure lies between entries. In an implementation, the stored arbitrary data is generated according to the requirement, relying on the fact that cache entries stay at the same positions. In another implementation, the stored arbitrary data is updated over time, relying on the fact that cache entries stay at the same positions.

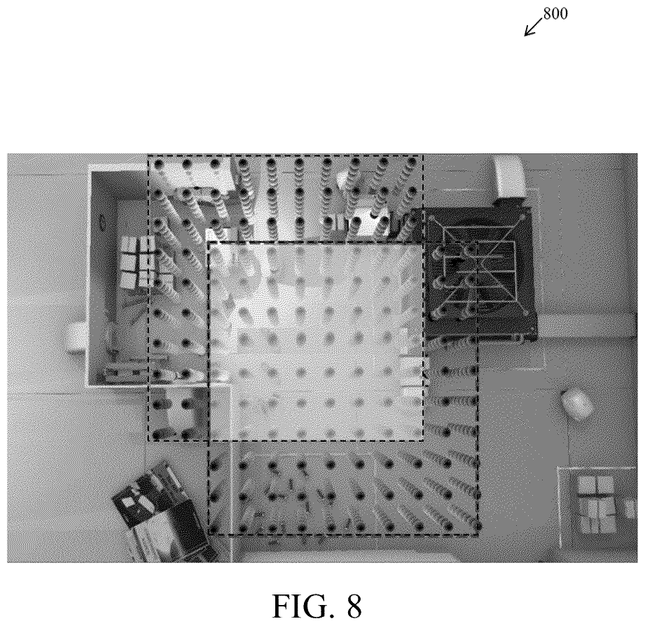

FIG. 8 is an implementation scenario that depicts multi-viewer dynamic diffuse global illumination with activity, in accordance with an embodiment of the present disclosure. FIG. 8 is described in conjunction with elements from FIGS. 1, 2, 3A, 3B, 4A, 4B, 5A, 5B, 6A, 6B, 7A and 7B. With reference to FIG. 8, there is shown an implementation scenario 800 that depicts multi-viewer dynamic diffuse global illumination with activity.

The cache associated with the space is required for certain areas like, the areas with visible surfaces and in a reach of light. In an implementation, only a subset of cache entries is active. In another implementation, allocated cache entries are disabled. In yet another implementation, the cache entries are never activated and never allocated. Further, a list of all active rendering cache associated with the space is kept per effect in order to efficiently fill the caches. The rendering caches associated with the plurality of objects 112 are updated when the cache associated with the space is sampled. In an implementation, the resolution of the rendering caches associated with the space depends on the distance to the viewers. In another implementation, the resolution of the rendering caches associated with the space depends on the screen space derivatives projected back to the 3D scene 110. Further, the rendering caches associated with the space are handled in tiles. Although, the rendering caches associated with the space are also handled as individual entries during allocation. The rendering caches associated with the space are filled similar as the rendering caches associated with the plurality of objects 112 are filled.

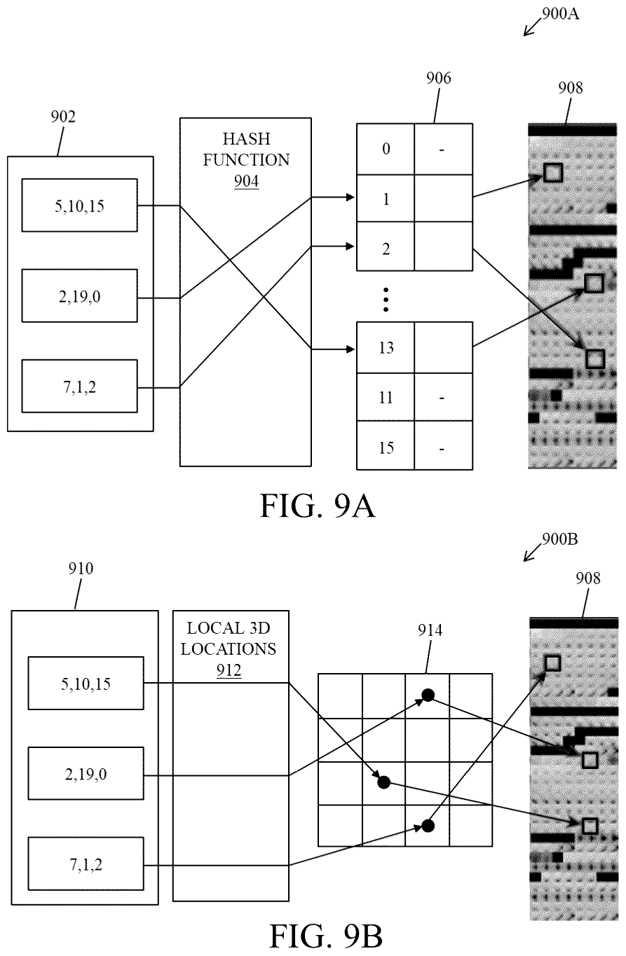

FIG. 9A is an implementation scenario that depicts hash based free-space memory management, in accordance with an embodiment of the present disclosure. FIG. 9A is described in conjunction with elements from FIGS. 1, 2, 3A, 3B, 4A, 4B, 5A, 5B, 6A, 6B, 7A, 7B and 8. With reference to FIG. 9A, there is shown an implementation scenario 900A that depicts a plurality of keys 902, a hash function 904, a plurality of table entries 906, a texture memory 908.

In an implementation, the rendering controller 102 is configured to use a shared hash table across levels to allocate the cache associated with the space. The rendering controller 102 is further configured to use a lookup table after allocation of the cache associated with the space. Further, the lookup table is mapped from the location in the 3D scene 110 to the cache entry that is presented in a dense way. If the lookup table for a tile is null, then an entry is allocated for the corresponding tile. Further, the rendering controller 102 is configured to use the hash function 904 that takes a 3D coordination of the tile which includes the plurality of keys 902 that is required to be allocated, to scatter the memory allocation request. The rendering controller 102 is configured to use atomic operations for the memory allocation. The hash function 904 assures about same location for multiple allocation and avoids double allocation. In an implementation, the cache entries are deallocated if they are not used over time. In another implementation, the cache entries are deallocated if a hard-deallocation criteria is met. In other words, deallocation sets the lookup tables and the hash map to zero. Further, the hard deallocation criteria include the distance to viewers or deactivation due to occlusion. Furthermore, the deallocation is handled with a simple update flag storing the last access frame to the entry. Moreover, a parallel inspection of all entries is used by the rendering controller 102 for deallocation.

FIG. 9B is an implementation scenario that depicts difference between global and local lookup table, in accordance with an embodiment of the present disclosure. FIG. 9B is described in conjunction with elements from FIGS. 1, 2, 3A, 3B, 4A, 4B, 5A, 5B, 6A, 6B, 7A, 7B, 8, and 9A. With reference to FIG. 9B, there is shown an implementation scenario 900B that depicts a plurality of global 3D locations 910, local 3D locations 912, a lookup texture 914.

The lookup table provides a record of null tiles and entry allocated tiles. The numerical data representation boxes are the global lookup table that include the location in the 3D scene 110. Further, the numerical data represented in the global lookup table is passed through the local lookup table and thereafter reaches at a lookup texture in which each allocated tile is recorded. Furthermore, the cache entry is stored in the allocated tile.

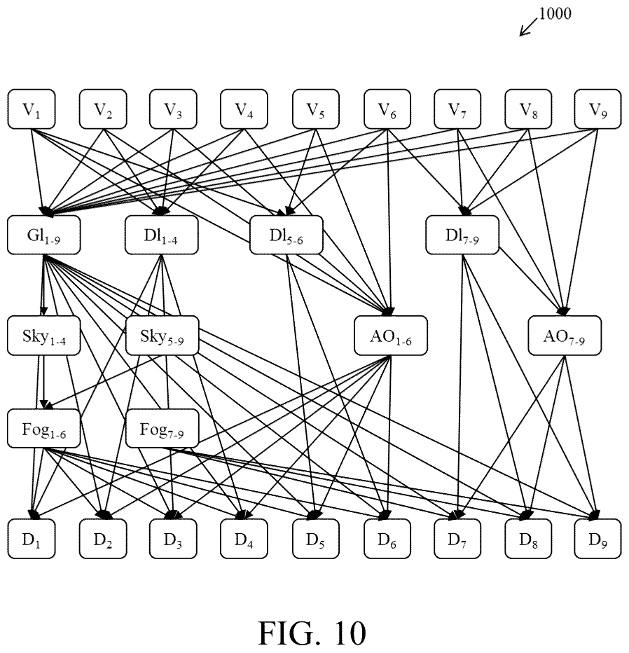

FIG. 10 is an illustration of a multi-viewer distribution scheme, in accordance with an embodiment of the present disclosure. FIG. 10 is described in conjunction with elements from FIGS. 1, 2, 3A, 3B, 4A, 4B, 5A, 5B, 6A, 6B, 7A, 7B, 8, 9A and 9B. With reference to FIG. 10, there is shown the multi-viewer distribution scheme 1000, including a visibility (V) 1-9, global illumination node 1-9, sky 1-9, fog 1-9, display (D) 1-9 and ambient occlusion (AO) 1-9.

Conventionally, distributed rendering was only used in offline rendering and performed as a frame-by-frame approach. Further, the conventional approach does not offer reusability and duplicates the process of rendering. According to the approach disclosed in the FIG. 10, the rendering controller 102 is configured to perform distribution of the rendering cache on the effect basis, therefore the rendering controller 102 allows different nodes to compute different effects. Further, the effects may be rendered with different frequencies and different latency requirements and a result generated by rendering the effects is used to construct final output image for the scene view of the corresponding viewer from the plurality of viewers 108. In an implementation, the memory transfer may be reduced by placing the viewers from the plurality of viewers 108 on the same node if similar caches are required by the corresponding viewers from the plurality of viewers 108.

In accordance with an embodiment, the rendering controller 102 is further configured to determine a global illumination node 1-9 and to determine rendering characteristics based on global illumination for all scene views in the global illumination node 1-9. The global illumination node is being the most compute intensive runs separately, as due sky 1-9 computations and AO 1-9. The global illumination node 1-9 is compatible with a fog, as the fog 1-9 run efficiently on the global illumination node. Further, the V 1-9, D 1-9 and AO 1-9 need to run in every frame, whereas the global illumination node, a sky 1-9 and the fog 1-9 run with reduced frame rate. Furthermore, through the rendering controller 102 compute the rendering caches so the rendering is distributed per effect and combinations for different viewers from the plurality of viewers 108 is possible. Moreover, the rendering controller 102 is compatible with an edge rendering system. In an implementation, in the edge rendering system, the effects that change slowly is computed further from the receiver while the final image generation is performed close to the output. In another implementation, in the edge rendering system, the effects which is predicted for the future, is computed further from the receiver while the final image generation performed close to the output.

In addition to aforementioned implementation scenarios, the rendering controller 102 may be further configured to provide a consistent space across time that allows a 1:1 data access from frame to frame without the requirement to track any object movement or resampling. A simple direct cache access is sufficient. Moreover, the rendering controller 102 may be configured to provide the cache associated with the space that allows access to neighboring data that does not span depth discontinuities. The caches associated with the space allow for spatio-temporal reuse. Further, the caches associated with the space may be accessed in the absence of one screen space. Moreover, the caches associated with the space provide more efficient spaces for spatio-temporal reuse.

In another addition to aforementioned implementation scenarios, spatial sharing and filtering is directly supported by the rendering cache associated with the space. Further, the rendering controller 102 avoids discontinuities and occlusions. Further, the rendering cache associated with the space enables the reuse of the spatial computation and sharing between samples, such as filtering becomes straight-forward.

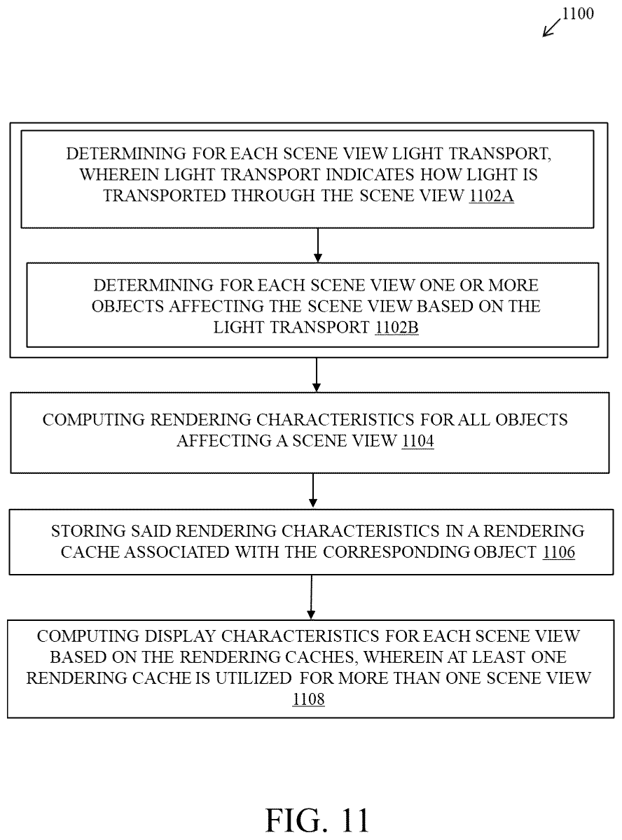

FIG. 11 is a flow chart of a method for use in rendering controller, in accordance with an embodiment of the present disclosure. FIG. 11 is described in conjunction with elements from FIGS. 1, 2, 3A, 3B, 4A, 4B, 5A, 5B, 6A, 6B, 7A, 7B, 8, 9A, 9B and 10. With reference to FIG. 11, there is shown a flow chart of a method 1100 for use in rendering controller 102. The method 1100 includes steps 1102A, 1102B, 1104, 1106, and 1108.

There is provided the method 1100 for use in a rendering controller 102. The method 1100 provides a hassle-free way to render image in a cloud environment. The method 1100 provides a way to share cache data among plurality of viewers 108 viewing the same objects in a 3D scene 110.

A method 1100 for use in a rendering controller 102 configured to render a three-dimensional (3D) scene 110 for the plurality of viewers 108. The 3D scene 110 includes a plurality of objects 112 and each viewer having a scene view of the 3D scene 110. Further, each scene view is affected by one or more of the plurality of objects 112. The method 1100 is further configured to manage the scene view of the 3D scene 110 for each viewer. The 3D scene 110 refers to a virtual construct (e.g., a virtual model) designed through any suitable 3D modelling technique and computer assisted drawings (CAD) methods that enables exploration thereof and communications between users through their corresponding virtual characters. Thus, the 3D scene 110 may be a virtual meeting platform or videoconferencing platform having a virtual setting where users may walk around, see each other's virtual character, and communicate with each other. Examples of the 3D scene 110 may include, but are not limited to, a 3D roller coaster, a 3D haunted house in an entertainment park, an entertainment park, 3D video games, a 3D museum, a 3D city, school, factory, or any venue, and the like. Further, the plurality of objects 112 in the 3D scene 110 are virtual objects imitating real objects that may include but are not limited to a vehicle (e.g., a car), a plurality of vehicles, a plurality of buildings, and the like. The scene view of the 3D scene 110 includes front scene view, back scene view, side scene views and the like. Furthermore, the one or more of the plurality of objects 112 affects each scene view as the scene view changes when a viewer changes its position in the 3D scene 110. In an implementation, the change in position of each viewer leads to change in perspective of the one or more of the plurality of objects 112 that affects the scene view of the 3D scene 110. In another implementation, the change in position of each viewer leads to appearance of a new object that affects the scene view of the 3D scene 110.

At step 1102A the method 1100 comprises determining light transport for each scene view. Further, the light transport indicates how light is transported through the scene view. The method 1100 determine the light transport through a general caching system with an affinity to the 3D scene 110 that is rendered from various viewpoints.

At step 1102B the method 1100 further comprises determining one or more objects affecting the scene view based on the light transport for each scene view. In other words, the light transport provides a view of the one or more objects affecting the scene view. Further, the light transport provides the view of only a part of the object that is visible from a particular angle.

At step 1104 the method 1100 further comprises computing rendering characteristics for all objects affecting a scene view. The rendering characteristics includes ideal location and resolution of caches. Further, if the plurality of viewers 108 view the one or more objects in the 3D scene 110 from similar angles, then the same object appears in each scene view of the corresponding viewers. In such scenario, the caches are merged for each scene view of the corresponding viewers to reduce the number of caches that are generated. In an implementation, the caches of the scene view of the first viewer 108A and the caches of the scene view of the second viewer 108B are merged. In another implementation, the caches of the scene view of the first viewer 108A, second viewer 108B and Nth viewer are merged.

At step 1106 the method 1100 further comprises storing said rendering characteristics in a rendering cache associated with the corresponding object. The rendering cache is considered as a virtual memory system which is configured to store the rendering characteristics associated with the corresponding object from the plurality of objects 112. The rendering cache may capture intermediate values of light transport affecting the one or more objects from the plurality of objects 112. The rendering cache may be classified as an on-surface cache and an in-space cache. The on-surface cache is sparse and multi-resolution in nature. The on-surface-cache can be stored on the surface of 3D objects in a virtual scene and the rendering computations can be shared among the plurality of viewers 108. The in-space cache is configured to capture a sparse, hierarchical grid in a virtual scene of 3D objects. Further, the memory management for caches on the surfaces of the plurality of objects 112 is performed on multiple granularities.

At step 1108 the method 1100 further comprises computing display characteristics for each scene view based on the rendering caches and at least one rendering cache is utilized for more than one scene view. The rendering cache is generated in such a way that the generation of the rendering cache is distributed between different compute nodes and merging computations based on required data, such as scene geometry, textures, and the like. The temporal coherence and progressive cache updates based on the type of effect, required update frequency and available compute power are used. The transfer of cache data from generation nodes to display nodes, where the final views for individual viewers are synthesized. The plurality of viewers 108 are grouped based on their cache requirements, closeness in the 3D scene 110, and data residency. Moreover, the virtual cache memory is managed by various parameters like, location of the plurality of viewers 108, an orientation of the plurality of viewers 108, a geometric constellation of the 3D scene 110 and effects considered by the rendering approach.

In accordance with an embodiment, when loaded into and executed by the rendering controller 102, enables the rendering controller 102 to execute the method 1100. The rendering controller 102 performs the tasks according to the method 1100. The method 1100 is configured to store the caches associated with the surface and the caches associated with the space. Further, the method 1100 merge caches among the scene views of the viewers from the plurality of viewers 108 whose scene view overlap with each other's scene view.

The method 1100 used in the rendering controller 102 provides an efficient way to share different scene views of the 3D scene 110 by reuse of the rendering computations. Further, method 1100 decreases the cost by reducing the light transport computations because they are costly to compute. The method 1100 splits the rendering computations and enables parallelization and pipelining across compute nodes. Further, the method 1100 is configured to perform sharing of rendering computations among the plurality of viewers 108 in the 3D scene 110 which leads to a decrease in the rendering cost as well. This way of performing the rendering in the cloud allows a wider scaling, as the method 1100 scales rendering in a significantly improved way. Furthermore, the method 1100 enables the spatial reuse as well as the temporal reuse of the rendering computations. The method 1100 does not rely on the screen space for storage and reuse of the effect computations as it leads to resampling issues over time and discontinuities in space across boundaries of the object. The method 1100 is configured to store and reuse rendering computations. Further, the method 1100 provides a new space to reuse the rendering computations over time without resampling.

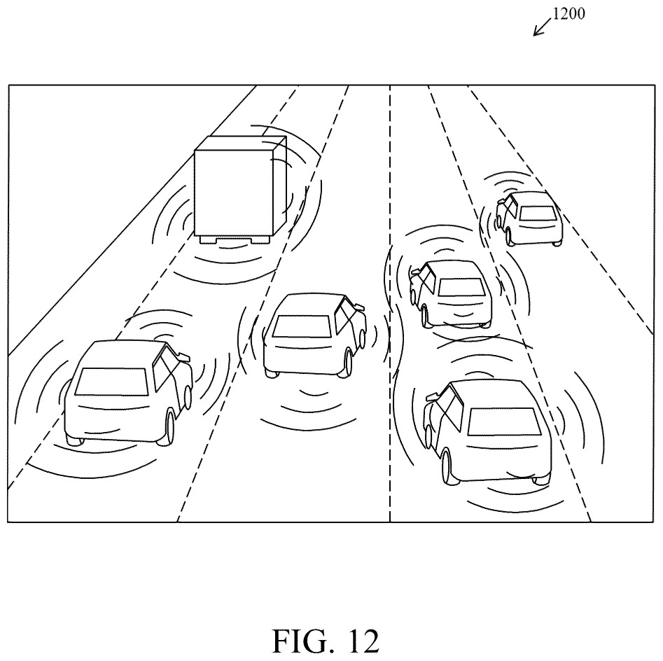

FIG. 12 is an implementation scenario that depicts sharing of rendering computations between cameras of autonomous vehicles, in accordance with an embodiment of the present disclosure. FIG. 12 is described in conjunction with elements from FIGS. 1, 2, 3A, 3B, 4A, 4B, 5A, 5B, 6A, 6B, 7A, 7B, 8, 9A, 9B, 10 and 11. With reference to FIG. 12, there is shown an implementation scenario 1200 that depicts sharing of rendering computations between cameras of autonomous vehicles.

In the implementation scenario 1200, there are a plurality of cars, and each car comprises a large number of camera sensors and actuators to perform autonomous driving. Further, the plurality of cars includes driving simulator which receives input from the camera sensors and actuators. As the plurality of cars moves, new images are required to be rendered. Furthermore, the scene view of each camera sensor remains similar due to the presence of the plurality of cars in nearby. In such scenario, the rendering controller 102 is configured to store intermediate rendering results. The rendering controller 102 is configured to rely on the rendering caches to enable temporal reuse as well as sharing computations between the different cameras associated with each car from the plurality of cars and to replace objects and textures, partial rendering results can be cached and reused as well. In this way, the rendering controller 102 reduces the rendering work and may lead to significantly reduced training time and computations.

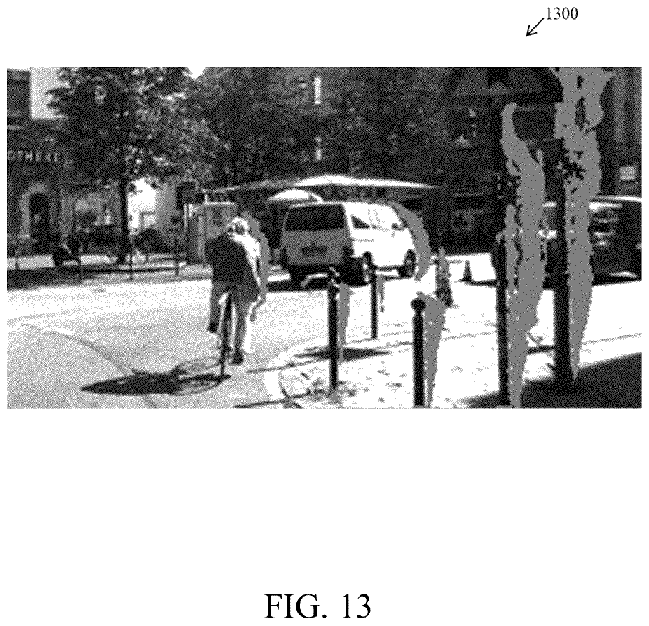

FIG. 13 is an implementation scenario that depicts capture occluded and reappearing parts of scenes, in accordance with an embodiment of the present disclosure. FIG. 13 is described in conjunction with elements from FIGS. 1, 2, 3A, 3B, 4A, 4B, 5A, 5B, 6A, 6B, 7A, 7B, 8, 9A, 9B, 10, and 11. With reference to FIG. 12, there is shown an implementation scenario 1300 that depicts capture occluded and reappearing parts of scenes.

Conventionally, a temporal reuse is carried out in a screen space. As one or more objects from the plurality of objects 112 moves through the scene view and or one or more cameras rotate, then sample locations changes from frame to frame. In this scenario, the one or more objects from the plurality of objects 112 are sometimes visible and sometimes invisible. Moreover, the temporal reuse is also prohibited in such scenario. To avoid this problem, the rendering controller 102 is configured to store the location on the surface and in the space of the 3D scene 110, such that the rendering caches are consistent over time. Thereafter, the same sample location is identified in arbitrary previous frames and stays consistent across time. By this way, the rendering controller 102 avoids diffusion effects and even if the visibility of the one or more objects from the plurality of objects 112 fluctuates, then also, the latest cached information may be accessed throughout the time. In this way, the rendering controller 102 is configured to use a more efficient and higher quality technique for temporal reuse computations without considering that the caching is used in a multi-viewer setup or not.

Moreover, in another implementation scenario, a cloud gaming includes multiple participants (i.e., the plurality of viewers 108) who access the 3D scene 110 together, so the rendering controller 102 shares rendering computations among all the participants. Through this way, the rendering controller 102 reduces the number of computations required for each participant and thus, results in saving resources in the cloud computations. Conventionally, the cloud gaming with large number of participants is avoided because load on a conventional server becomes too high and synchronization with on premise game instances becomes troublesome. But the rendering controller 102 solves the problem by sharing the rendering computations among the participants to release the stress on the server 202 and enhances the cloud gaming experience of the participants.

In yet another implementation scenario, the rendering controller 102 may be used to host a virtual exhibition. As the virtual exhibition may include thousands of participants (e.g., the plurality of viewers 108) who may look at one object. The rendering controller 102 can store caches on the surface and in the space, which can be shared among thousands of participants. Thus, the rendering controller 102 is configured to perform a high-quality rendering.

In yet another implementation scenario, an image generation is a highly required feature for a virtual environment, such as metaverse or omniverse. The rendering controller 102 may be used in such virtual environment to reduce rendering load by caching and reusing the rendering computations for the plurality of viewers 108. The rendering controller 102 may share the rendering computations among the plurality of viewers 108 who are viewing the 3D scene 110 in the same virtual environment. In an implementation, the rendering controller 102 is also used for simulation of multi-camera systems, or autonomous agents.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the disclosure, which are, for brevity, described in the context of a single embodiment, may also be provided separately or in any suitable combination or as suitable in any other described embodiment of the disclosure.

1. A rendering controller configured to render a three-dimensional (3D) scene for a plurality of viewers, wherein the 3D scene comprises a first plurality of objects and each viewer has a scene view of the 3D scene, wherein each scene view is affected by one or more of the first plurality of objects, wherein the rendering controller comprises at least one processor and one or more memories coupled to the at least one processor and storing programming instructions for execution by the at least one processor to:
determine light transport for each scene view, wherein the light transport indicates how light is transported through the scene view;
determine, for each scene view, one or more objects affecting the scene view based on the light transport;
compute respective rendering characteristics for each of a second plurality of objects affecting a scene view;
store the respective rendering characteristics in a rendering cache associated with a corresponding object of the second plurality of objects, wherein the second plurality of objects are associated with a plurality of rendering caches; and
compute display characteristics for the scene view based on the plurality of rendering caches, wherein at least one rendering cache of the plurality of rendering caches is utilized for more than one scene view.

2. The rendering controller according to claim 1, wherein the programming instructions are for execution by the at least one processor to:
determine a space in the 3D scene, the space comprising multiple light transport events;
compute rendering characteristics for the space; and
store the rendering characteristics in a rendering cache associated with the space.

3. The rendering controller according to claim 1, wherein the programming instructions are for execution by the at least one processor to:
associate one or more scene views in a subset, wherein two scene views are associated if they are overlapping;
determine a first compute node for computing a first aspect of light transport as part of the rendering characteristics for the subset; and
determine a second compute node for computing a second aspect of light transport as part of the rendering characteristics for the subset.

4. The rendering controller according to claim 3, wherein two scene views are associated if they are overlapping.

5. The rendering controller according to claim 3, wherein two scene views are associated if they cover areas within a threshold distance of one another.

6. The rendering controller according to claim 3, wherein two scene views are associated if originating view points are within a threshold distance of one another.

7. The rendering controller according to claim 2, wherein the programming instructions are for execution by the at least one processor to:
include the space in a subset, wherein the space is included in a scene view associated with the subset.

8. The rendering controller according to claim 1, wherein the programming instructions are for execution by the at least one processor to:
determine a view node for each scene view;
determine light transport; and
compute display characteristics for a scene view in the view node.

9. The rendering controller according to claim 1, wherein an object affects a first and a second scene view, and wherein the programming instructions are for execution by the at least one processor to:
compute the rendering characteristics for the object only for the first scene view.

10. The rendering controller according to claim 1, wherein the programming instructions are for execution by the at least one processor to:
determine a global illumination node; and
determine rendering characteristics based on global illumination for all scene views in the global illumination node.

11. The rendering controller according to claim 1, wherein a scene view is affected by an object when at least one of:
the scene view comprises the object; or
the scene view receives light emanating from the object.

12. The rendering controller according to claim 1, wherein light transport includes secondary lighting.

13. The rendering controller according to claim 1, wherein the rendering controller is a cloud controller.

14. A method for use in a rendering controller configured to render a three-dimensional (3D) scene for a plurality of viewers, wherein the 3D scene comprises a first plurality of objects and each viewer has a scene view of the 3D scene, wherein each scene view is affected by one or more of the first plurality of objects, wherein the method comprises:
determining light transport for each scene view, wherein light transport indicates how light is transported through the scene view;
determining, for each scene view, one or more objects affecting the scene view based on the light transport;
computing respective rendering characteristics for each of a second plurality of objects affecting a scene view;
storing the respective rendering characteristics in a rendering cache associated with a corresponding object of the second plurality of objects, wherein the second plurality of objects are associated with a plurality of rendering caches; and
computing display characteristics for the scene view based on the plurality of rendering caches, wherein at least one rendering cache of the plurality of rendering caches is utilized for more than one scene view.

15. A computer-readable medium comprising computer instructions that, when loaded into and executed by a rendering controller, enables the rendering controller to perform operations comprising:
determining light transport for each scene view, wherein light transport indicates how light is transported through the scene view, wherein the rendering controller is configured to render a three-dimensional (3D) scene for a plurality of viewers, wherein the 3D scene comprises a first plurality of objects and each viewer has a scene view of the 3D scene, wherein each scene view is affected by one or more of the first plurality of objects;
determining, for each scene view, one or more objects affecting the scene view based on the light transport;
computing respective rendering characteristics for each of a second plurality of objects affecting a scene view;
storing the respective rendering characteristics in a rendering cache associated with a corresponding object of the second plurality of objects, wherein the second plurality of objects are associated with a plurality of rendering caches; and
computing display characteristics for the scene view based on the plurality of rendering caches, wherein at least one rendering cache of the plurality of rendering caches is utilized for more than one scene view.

16. The method according to claim 14, wherein the method comprises:
determining a space in the 3D scene, the space comprising multiple light transport events;
computing rendering characteristics for the space; and
storing the rendering characteristics in a rendering cache associated with the space.

17. The method according to claim 14, wherein the method comprises:
associating one or more scene views in a subset, wherein two scene views are associated if they are overlapping;
determining a first compute node for computing a first aspect of light transport as part of the rendering characteristics for the subset; and
determining a second compute node for computing a second aspect of light transport as part of the rendering characteristics for the subset.

18. The method according to claim 17, wherein two scene views are associated if they are overlapping.

19. The computer-readable medium according to claim 15, wherein the operations comprise:
determining a space in the 3D scene, the space comprising multiple light transport events;
computing rendering characteristics for the space; and
storing the rendering characteristics in a rendering cache associated with the space.

20. The computer-readable medium according to claim 15, wherein the operations comprise:
associating one or more scene views in a subset, wherein two scene views are associated if they are overlapping;
determining a first compute node for computing a first aspect of light transport as part of the rendering characteristics for the subset; and
determining a second compute node for computing a second aspect of light transport as part of the rendering characteristics for the subset.
